(19) United States
(12) Patent Application Publication
(10) Pub. No.: US 2011/0051302 A1
(43) Pub. Date: Mar. 3, 2011

(54) INTEGRATED POWER DEVICE AND METHOD

(75) Inventor: Donald Dibra, Muenchen (DE)

(73) Assignee: Infineon Technologies AG, Neubiberg (DE)

(21) Appl. No.: 12/549,089

(22) Filed: Aug. 27, 2009

(51) Int. Cl. H02H 3/00

(52) U.S. Cl. 361/86; 361/78

(57) ABSTRACT

A method of protecting a circuit arrangement including an integrated power dissipating device, and a circuit arrangement including an integrated power dissipating device. One method provides measuring a temperature difference between temperatures at a first position and a second position of the arrangement, the second position being distant to the first position; generating a thermal protection signal, and generating the control signal dependent on the thermal protection signal; and the thermal protection signal assuming a first signal level, if the temperature difference rises to a first temperature difference threshold, and assuming a second signal level, if the temperature difference falls to a second temperature difference threshold.

### TECHNICAL FIELD

The present disclosure relates to thermal protection of integrated power devices.

### BACKGROUND

If integrated power devices are subject to overload conditions, their temperature increases. Integrated power devices are, for example, power switches, such as power MOSFET or power IGBT. If power switches are subject to overload conditions, such as a short-circuit in a load connected to the switch, their temperature increases. One protection method for protecting power devices against overload conditions involves measuring the temperature of the power device, and switching off the switch, if the temperature exceeds a given temperature threshold. Typically the temperature is measured in the “hot spot”. The hot spot is the location in a semiconductor body, in which the device is integrated, that has the highest temperature.

Another protection method involves measuring the hot spot temperature and an ambient temperature, and switching off the power switch, if a temperature difference between these two temperatures exceeds a given temperature difference threshold.

For these and other reasons there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 schematically illustrates a circuit arrangement that includes an integrated power dissipating device, a drive circuit, and a thermal protection circuit.

FIG. 2 schematically illustrates one embodiment of a drive circuit.

FIG. 3 illustrates timing diagrams illustrating the functionality of a thermal protection circuit according to one example.

FIG. 4 illustrates the dependency of a first temperature difference threshold value on the temperature according to one example.

FIG. 5 illustrates the dependency of a second temperature difference threshold value on the temperature according to an example.

FIG. 6 illustrates a thermal protection circuit having a sensor arrangement, an reference signal generator, and an evaluation circuit.

FIG. 7 schematically illustrates a top view on a semiconductor body in which a power dissipating device is integrated.

FIG. 8 schematically illustrates a cross section through a chip-on-chip semiconductor arrangement in which an integrated power dissipating device is integrated.

FIG. 9 schematically illustrates a cross section through a chip-by-chip semiconductor arrangement in which an integrated power dissipating device is integrated.

FIG. 10 illustrates a thermal protection circuit that includes a sensor arrangement having two temperature sensors.

FIG. 11 illustrates temperature sensors that include diodes.

FIG. 12 illustrates a first example of the reference signal generator.

FIG. 13 illustrates a first example of the evaluation circuit.

FIG. 14 illustrates a second example of the evaluation circuit.

FIG. 15 illustrates a further example of a thermal protection circuit, the thermal protection circuit having a sensor arrangement that includes a temperature difference sensor and a further temperature sensor.

FIG. 16 illustrates a first example of the further temperature sensor.

FIG. 17 illustrates a second example of the further temperature sensor.

FIG. 18 illustrates a third example of the thermal protection circuit.

FIG. 19 illustrates an example of the evaluation circuit of the thermal protection circuit according to FIG. 17.

FIG. 20 illustrates a further example of the evaluation circuit.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present disclosure relates to a circuit arrangement that includes an integrated power dissipating device and to a method of protecting the circuit arrangement from being overheated. In connection with this disclosure a “power dissipating device” is a device that during its operation dissipates power. “To dissipate power” in this connection means that the device partly converts the electrical power it receives into heat, with the heat being dissipated.

A first embodiment relates to a method of protecting a circuit arrangement including an integrated power dissipating device, the power dissipating device having a control terminal for receiving a control signal. The method includes: measuring a temperature difference between temperatures at a first position and a second position of the arrangement, the second position being distant to the first position. A thermal protection signal is generated, and the control signal is generated dependent on the thermal protection signal. The thermal protection signal assumes a first signal level, if the temperature difference rises to a first temperature difference threshold, and a second signal level, if the temperature difference falls to a second temperature difference threshold. At least one of the first and second temperature thresholds is dependent on the temperature at the second position or at a third position of the circuit arrangement.

Another embodiment relates to a circuit arrangement that includes an integrated power dissipating device having a control terminal for receiving a control signal, and a thermal protection circuit, the thermal protection circuit being configured to measure a temperature difference between temperatures at a first position and a second position of the arrangement, the second position being distant to the first position, and to generate a thermal protection signal. The thermal protection signal assumes a first signal level, if the temperature difference rises to a first temperature difference threshold, and assumes a second signal level, if the temperature difference falls to a second temperature difference threshold. The circuit arrangement further includes a drive circuit receiving the thermal protection signal and being configured to generate the control signal dependent on the thermal protection signal.

The circuit arrangement and the method will be described with respect to exemplary embodiments in a specific context, namely a context in which the power dissipating device is a power transistor that is used as a power switch that can be turned on and off. However, this is only an example. The concepts explained below are, of course, also applicable to other circuit arrangements including other power dissipating devices, such as, for example, power amplifiers. Power amplifiers include, for example a power transistor that is operated as an amplifier element (in its linear region). In the following it will be described that the power switch is turned off, if an overload condition is detected. Likewise, any other dissipating device, such as an amplifier or a power transistor operated in its linear region, is turned off under such overload conditions.

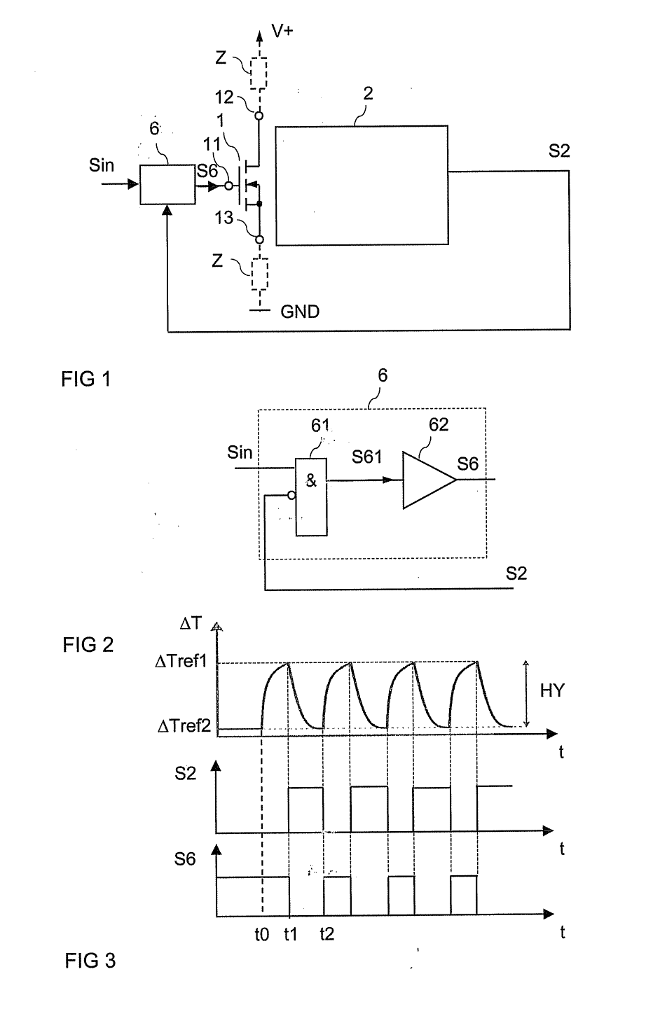

FIG. 1 schematically illustrates an example embodiment of a circuit arrangement that includes an integrated power switch 1 as a power dissipating device. In the present example power switch 1 is a power MOSFET. However, any other power switch, such as a power IGBT, may be used as well. The power switch 1 has a control terminal 11 for receiving a control signal S6, and first and second load terminals 12, 13. In case of a power MOSEFT control terminal 11 is a gate terminal and first and second load terminals 12, 13 are drain and source terminals. In case of a power IGBT the control terminal is a gate terminal, and first and second load terminals are collector (anode) and emitter (cathode) terminals.

As illustrated in dashed lines power switch 1 can be used for switching an electrical load. Load Z is connected in series to the load path of the power switch, the load path running between the first and second load terminals 12, 13. The series circuit including the load Z and the power switch 11 is connected between a first and a second supply terminal for first and second supply potentials V+, GND. In FIG. 1 first supply potential V+ is a positive supply potential, an second supply potential GND is a negative supply potential or a reference potential, such as ground. As illustrated, load Z may be connected between any of the two load terminals 12, 13 and one of the supply terminals. Power switch 1 acts as a Low-Side switch, if the load is connected between the first load terminal 12 and the first supply potential V+, and power switch 1 acts as a High-Side switch, if load Z is connected between the second load terminal 13 and the second supply potential GND. Load Z may be any electrical load. The amplitude of a supply voltage that is present between the two supply terminals is selected to be suitable for the specific load. Power switch 1 is selected to have a voltage blocking capability (maximum blocking voltage) that is sufficiently high to block the supply voltage in case power switch 1 is switched off.

Control signal S6, that is applied to control terminal 11, switches power switch 1 on or off dependent on its signal level. For explanation purposes it may be assumed that control signal S6 can assume one of two signal levels: first signal level, which will be referred to as on-level in the following, that switches power switch 1 on; and a second signal level which will be referred to as off-level in the following, that switches power switch 1 off.

The circuit arrangement includes a drive circuit 6 that generates control signal S6 dependent on an input signal Sin. Input signal Sin may be provided by any suitable logic circuit such as a microcontroller. Input signal Sin defines a desired switching state of power switch 1. In a normal operation state of the circuit arrangement control signal S6 is dependent on input signal Sin, i.e. power switch 1 is switched on, if input signal Sin has an on-level, and power switch 1 is switched of if input signal Sin has an off-level.

The circuit arrangement further includes a thermal protection circuit 2 that protects power switch 1 against overheating in case of circuit failures, such as a short-circuit in the load Z. If such short-circuit occurs the supply voltage, that is present between the supply terminals, almost completely drops across the load path of power switch 1. This results in an increasing power loss in the power switch and in a rapidly increasing temperature of power switch 1. Thermal protection circuit 2 is configured to detect overheating scenarios and generates a thermal protection signal S2. Thermal protection signal S2 can assume two different signal levels: a first signal level indicating an overheating or the risk of an overheating of the integrated power switch 1; and a second signal level indicating a normal operation state or a normal temperature scenario of the integrated power switch 1. The first signal level of thermal protection signal S2 will also be referred to as fault level or overheating level in the following, and the second signal level will also be referred to as normal level.

Power switch 1 is switched off, if thermal protection signal S2 assumes the fault level. In the example according to FIG. 1 drive circuit 6 receives the thermal protection signal S2 and generates the control signal S6 dependent on the thermal protection signal S2, where drive circuit 6 is configured to generate an off-level of control signal S6 if thermal protection signal S6 assumes its fault level. If thermal protection signal S6 assumes its normal signal level, then control signal S6 is governed by input signal Sin, i.e. power switch 1 is switched on if input signal Sin has an on-level, and power switch 1 is switched off if input signal Sin has an off-level. If thermal protection signal S2 has its fault level, then power switch 1 is switched off ignoring the signal level of input signal Sin.

For illustration purposes FIG. 2 illustrates one example embodiment of a driver circuit 6 having the functionality as described above. Driver circuit 6 has a logic gate receiving input signal Sin and thermal protection signal S2 and provides an output signal S61 that is dependent on these two signals Sin, S2. An optional output stage or driver stage 62 amplifies signal S61 to provide control signal S6. The output signal of logic gate 61 may be logic signal having a signal amplitude of, for example, in a range between 1V and 5V, while control signal S6 may have an amplitude of, for example, up to 15V.

The output signal S61 of logic gate 61 has the signal level of input signal Sin, if the thermal protection signal S2 has its normal level, and the output signal S61 has an off-level for switching power switch 1 off, if thermal protection signal S2 has its fault level. In the example according to FIG. 2 logic gate 61 is an AND-gate that receives an input signal Sin at a first input and thermal protection signal S2 at a second inverting input. The drive circuit as illustrated in FIG. 2 is suitable for a signal scenario where the on-level of input signal Sin and control signal S6 is a high-level, the off-level of input Sin and control signal S6 is a low-level, and the fault level of thermal protection signal S2 is a high-level. This is only an example, other signalling scenarios may be applied as well, where logic gate 61 has to be configured accordingly.

Thermal protection circuit 2 is configured to measure a temperature difference between temperatures at two different positions of the circuit arrangement: a first position, and a second position being distant to the first position. Thermal protection circuit 2 generates thermal protection signal S2 dependent on the measured temperature difference, thermal protection signal S2 being generated to assume its fault level, if the temperature difference rises to or above a first temperature difference threshold, and thermal protection signal S2 is generated to have its normal level, if the temperature difference subsequently falls to or below a lower second temperature difference threshold.

The functionality of thermal protection circuit 2 is illustrated in FIG. 3 in which an example of the temperature difference ΔT over time t, and timing diagrams of the thermal protection signal S2 and control signal S6 resulting from the temperature difference ΔT are illustrated. ΔTref1, ΔTref2 in FIG. 3 denote the first and second temperature difference thresholds. At the beginning of the timing diagrams illustrated in FIG. 3 power switch 1 is switched on (governed by input signal Sin). The temperature difference ΔT at the beginning is below the first threshold ΔTref1. At time t0 a fault state occurs resulting in an increasing temperature of power switch 1. In the circuit arrangement the first and second positions for temperature measurement are distant to one another and have different distances to integrated power switch 1. The first position is closer to the integrated power switch than the second position. If the temperature in the integrated power switch 1 increases due to a fault in the load the temperature at the first position increases earlier and faster than at the second position. An increase of the temperature at the first position therefore results in an increase of the temperature difference between these two positions. For this reason the temperature difference ΔT increases starting from time t0 when the fault condition occurs. Power switch 1 stays switched-on until the temperature difference ΔT reaches the first temperature difference threshold ΔTref1, which is at time t1 in the present example. At this time thermal protection signal S2 assumes its fault level (a high level in the example according to FIG. 3). Resulting from the fault level of thermal protection signal S2 power switch 1 is switched off by setting control signal S6 to its off-level (the low-level in the example according to FIG. 3). After power switch 1 has been switched off the absolute temperature at the first position and the temperature difference between the first and second positions decreases. If the temperature difference ΔT falls to the second lower temperature difference threshold ΔTref2 (at time t2 in the example according to FIG. 3) thermal protection signal S2 assumes its normal level, allowing power switch 1 to be switched on, if input signal Sin has an on-level. For the scenario illustrated in FIG. 3 it is assumed that input signal Sin has an on-level during the complete time frame illustrated in FIG. 3. If at time t2 the load is still in its fault state, temperature difference ΔT rises again after switch 1 has been switched on. Thermal protection signal S2 again assumes a fault-level, thereby switching off switch 1, if the temperature difference ΔT reaches the first threshold ΔTref1, assumes the normal level after the temperature difference ΔT has fallen to the second threshold ΔTref2, and so on.

It should be noted that additional protection may be provided, like means or mechanism that permanently switch power switch 1 off, if the power switch has gone through a given number of heating-up and cooling-down cycles during a given time.

Heating-up and subsequently cooling-down power switch 1 induces thermal-mechanical stress in the individual parts of the power switch 1, such as the semiconductor body (die), in which the power switch is integrated, bond wires, and electrical connections between the bond wires and the semiconductor body. Such thermal-mechanical stress may result in degradation or fatigue and may finally result in damage or destruction of power switch 1 or other parts of the circuit arrangement. Referring to FIG. 3 in a fault-state, such as a short-circuit in the load, a number of heating and cooling cycles may occur, where in each of these cycles the temperature difference ΔT increases to the first temperature difference threshold ΔTref1 and decreases to the second threshold ΔTref2. HY in FIG. 3 denotes a temperature difference swing or a hysteresis of the temperature difference ΔT.

It has been found that besides the amplitude of this hysteresis HY the ambient temperature, that is the temperature of the environment in which the circuit arrangement is employed, has an influence on degradation or fatigue processes. In order to obviate such degradation or fatigue processes thermal protection circuit 2 is configured to decrease the temperature difference swing HY with increasing ambient temperature. The ambient temperature can be the temperature that is the temperature at the second position in the circuit arrangement or can be the temperature at a further (third) position, with this position being located such that the temperature present at this position being representative for the ambient temperature. Thermal protection circuit 2 is configured to generate at least one of the first and second temperature difference thresholds ΔTref1, ΔTref2 dependent on the temperature at the second or third position, where this temperature will be referred to as ambient temperature in the following.

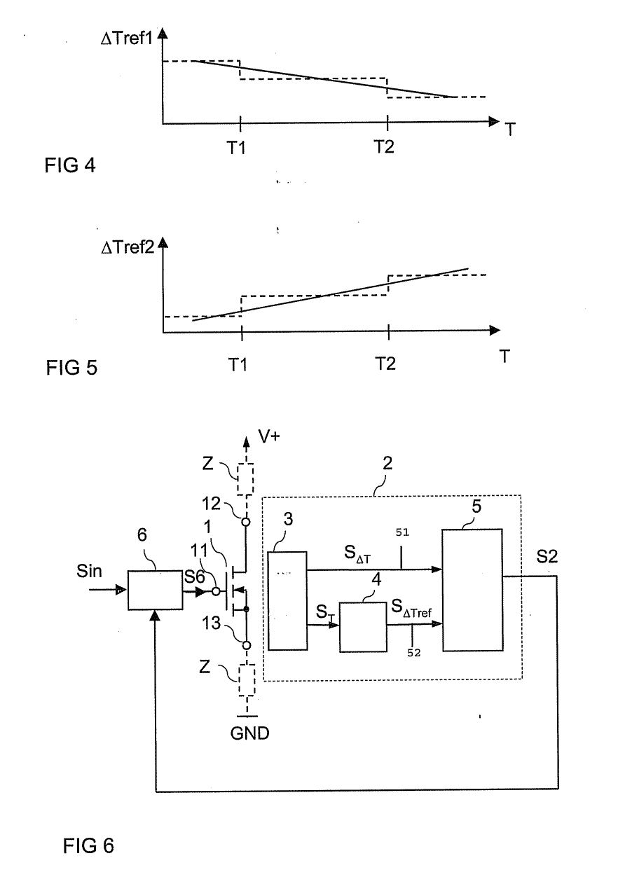

Referring to FIG. 4, according to one example the upper first temperature difference threshold ΔTref1 is dependent on the ambient temperature T, with the threshold ΔTref1 decreasing with increasing ambient temperature T for a given temperature range of ambient temperature T. As illustrated in FIG. 4 the first threshold ΔTref1 may continuously decrease with increasing ambient temperature T. This continuous decrease may be linear (as illustrated) or non-linear. As illustrated in dashed lines the threshold ΔTref1 may decrease in steps with increasing ambient temperature T. As illustrated in dashed lines threshold ΔTref1 may be constant for temperatures below a lower temperature threshold T1 and may be constant for temperatures higher than an upper temperature threshold T2 of ambient temperature T.

Instead of or additionally to decreasing the upper temperature difference threshold ΔTref1 with increasing ambient temperature T the lower temperature difference threshold ΔTref2 may increase with increasing ambient temperature T. An example for this is illustrated in FIG. 5. The increase of the lower threshold ΔTref2—similar to the decrease of the upper threshold ΔTref1—may be linear or non-linear. The lower threshold ΔTref2 may be constant for ambient temperatures below a lower threshold T1 and may be constant for temperatures higher than an upper threshold T2 of ambient temperature T.

According to the examples illustrated in dashed lines in FIGS. 4 and 5 the ambient temperature may be subdivided in three temperature ranges: A low temperature range that includes temperatures up to a first temperature T1; a medium temperature range that includes temperatures between the first temperature T1 and a higher second temperature T2; and a high temperature range that includes temperatures higher than the second temperature T2. The first temperature T1 is, for example, about 20° C., and the second temperature T2 is, for example, about 60° C. The first and the second temperature thresholds ΔTref1, ΔTref2 are selected to limit the hysteresis of the temperature difference ΔT to a first value HY1 for ambient temperature of the low range, to a second value HY2 for ambient temperatures of the medium range, and to a third value HY3 for ambient temperatures of the high temperature range. The first value HY1 is, for example, 90K, the second value HY2 is, for example, 60K, and the third value HY3 is, for example, 30K.

Referring to the example illustrated in FIG. 6 thermal protection circuit 2 may include a sensor arrangement 3 that provides a temperature difference signal S_{ΔT}, this temperature difference signal S_{ΔT} being representative of the temperature difference between the first and second positions in the circuit arrangement. Sensor arrangement 3 further provides an ambient temperature signal S_{T}, this ambient temperature signal S_{T} being representative of the ambient temperature T. Ambient temperature T may be the temperature at the second position or may be the temperature at a third position of the circuit arrangement, with the third position being distant to the first and second positions.

Thermal protection circuit 2 further includes a reference signal generator 4 that generates a temperature difference threshold signal S_{ΔTref} dependent on the ambient temperature signal S_{T}. The at least one threshold signal S_{ΔTref} represents one of the first and second temperature difference threshold ΔTref1, ΔTref2 that have been explained with reference to FIGS. 3 to 5. An evaluation circuit 5 receives temperature difference signal S_{ΔT} at a first input 51 and the at least one threshold signal S_{ΔTref} at a second input 52 and generates thermal protection signal S2 dependent on the temperature difference signal S_{ΔT} and threshold signal S_{ΔTref}.

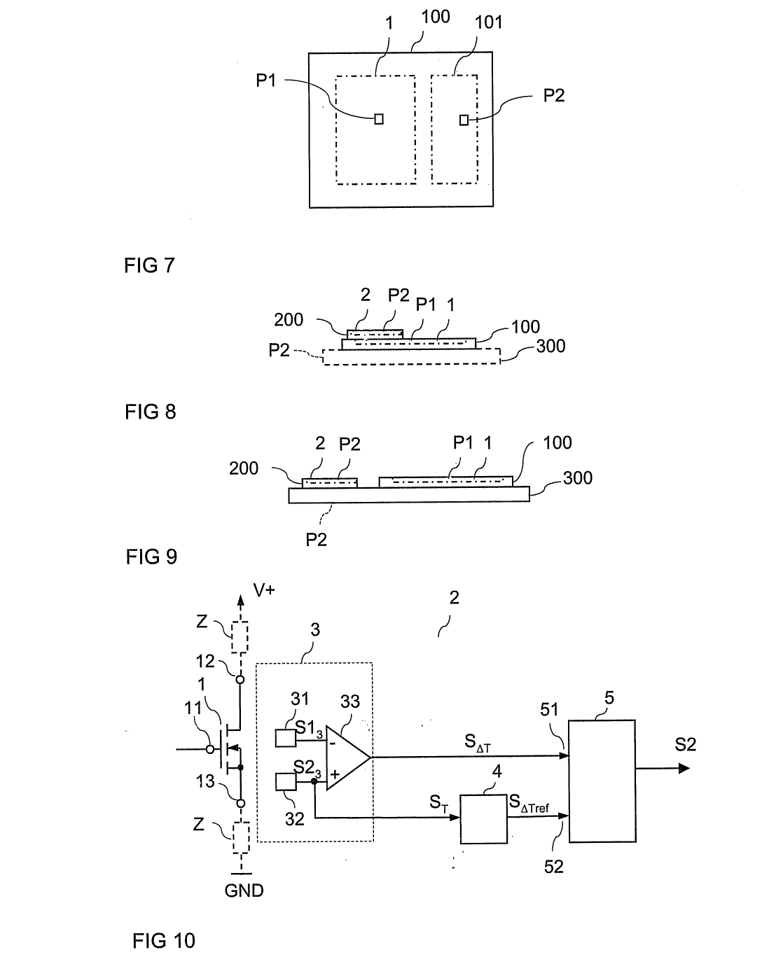

Examples for suitably selecting the first and second positions will now be explained with reference to FIGS. 7 to 9. FIG. 7 schematically illustrates a top view of a semiconductor body 100 in which active regions, such as source and drain regions, of power switch 1 are integrated. A section of the semiconductor body 100 in which the active regions of power switch 1 are integrated is schematically illustrated in dashed-dotted lines and has the same reference number 1 as the power switch in FIGS. 1 and 6. Power switches, such as power MOSFET or power IGBT typically include a number (for example up to several thousand or up to several ten thousand) identical cells (MOSFET cells or IGBT cells) that are connected in parallel. The region 1 of the semiconductor body 100 in which these cells are integrated is also referred to as cell area or cell region of the semiconductor body 100. This active region or cell region of the semiconductor body 100 is the region where most of the power losses that occur in the power switch 1 are dissipated. Thus, the cell region or active region is the region that has the highest temperature in the semiconductor body 100. The first position P1 is, for example, located in this active region or at the edge of this active region. For cooling the active region cooling means device, like a cooling body, may be employed. However, such cooling means are not illustrated in FIG. 7 for the sake of simplicity.

The second position P2 is distant to the first position P1 and distant to the hottest region in the semiconductor body 100, i.e. distant to the region including the cells of the power switch 1. The second position P2 may be located in an edge region that is close to the edge of the semiconductor body 100 and that may include edge-terminals (not illustrated). As illustrated in FIG. 7 the second position P2 may also be located in a logic region 101 of the semiconductor body 100, the logic region 101 including logic semiconductor devices, like parts of the drive circuit (6 in FIGS. 1 and 6) or the thermal protection circuit (2 in FIGS. 1 and 6). The temperature at the second position P2 can be representative of the ambient temperature, if there are means for cooling the semiconductor body 100, thereby avoiding the logic section 101 to be heated to the temperature of the active region or cell region.

Alternatively to integrating the power switch 1 and logic circuits in one semiconductor body 100, logic circuits, such as drive circuit 6 and thermal protection circuit 2, side and power switch 1 can also be integrated in two different semiconductor bodies. FIG. 8 schematically illustrates a vertical cross section through a semiconductor arrangement that includes a first semiconductor body 100 in which power switch 1 is integrated, and a second semiconductor body 200, in which logic circuits are integrated. The second semiconductor body 200 is arranged on top of the first semiconductor body 100 in a chip-on-chip arrangement. In this example the first position P1 is in the first semiconductor body 100 in the active region of the power switch 1, and the second position P2 is in the second semiconductor body 200.

Optionally the arrangement with the two semiconductor bodies (dies) 100, 200 is arranged on a carrier 300. This carrier 300 may have a cooling function and may additionally be mounted on a cooling body (not illustrated). According to a further example, the second position P2 is a position at or in the carrier 300.

FIG. 9 illustrates a cross section through a semiconductor arrangement that is different from the arrangement according to FIG. 8 in that the two semiconductor bodies 100, 200 are arranged on a carrier 300 next to each other in a chip-by-chip arrangement. Concerning the first and second positions P1, P2, the explanation that has been given with reference to FIG. 8 applies accordingly, i.e. first position P1 may be in the first semiconductor body 100, and the second position may be in the second semiconductor body 200 or at or in the carrier.

FIG. 10 illustrates one example embodiment of a sensor arrangement 3 that provides temperature difference signals S_{ΔT} and ambient temperature signal S_{T}. The sensor arrangement 3 includes two temperature sensors: a first temperature sensor 31 that is located at the first position P1 and that generates a first temperature signal S1₃, the first temperature signal S1₃ being representative of a first temperature at the first position P1; a second temperature sensor 32 that is located at the second position P2 and that generates a second temperature signal S2₃, the second temperature signal S2₃ being representative of the temperature at the second position P2, the second temperature being the ambient temperature in this case. An amplifier 33 receives the first and second temperature signals S1₃, S2₃. This amplifier 33 is configured to form the difference between the two temperature signals S1₃, S2₃ and to optionally amplify the difference. The amplifier gain is, for example between 1 and 10, like 1, 5 or 10.

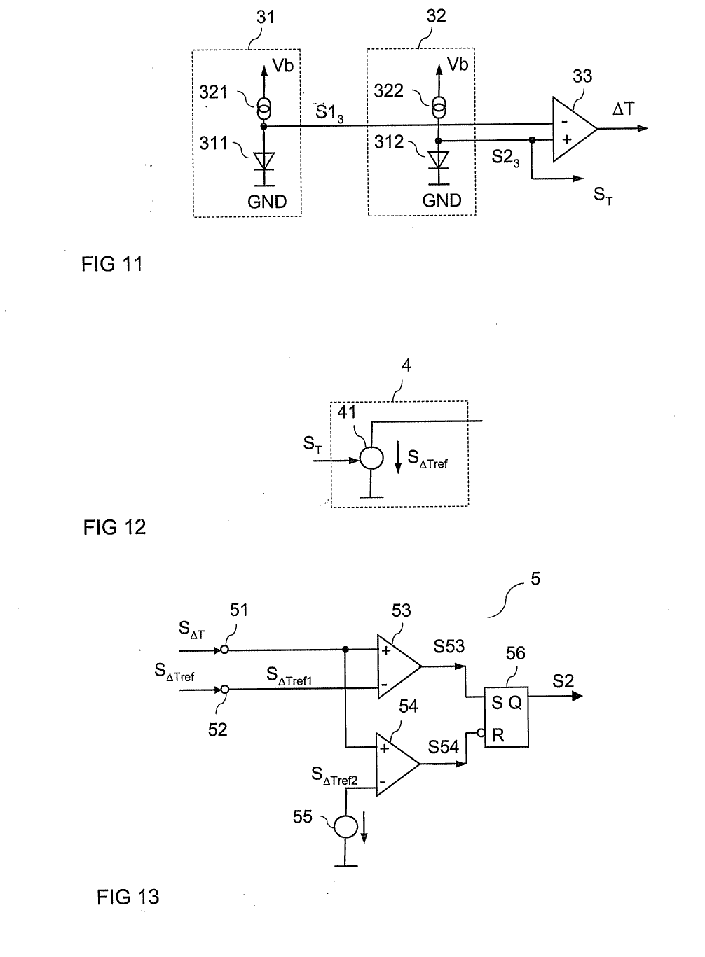

As the first and second sensors 31, 32 any suitable temperature sensors can be used that are configured to generate an electrical signal that has an amplitude which is dependent on the temperature in the region where the individual sensor is located. Referring to FIG. 11 sensors 31, 32 may include diodes 311, 312 as sensor elements. These sensor elements are connected in series to a current source 312, 322, with the series circuit being connected between a supply potential Vb and a reference potential, such as ground GND. Diodes 311, 312 are forward biased. The temperature signals S1₃, S2₃ are the voltage drops across the diodes 311, 312. Sensors, such as sensors 31, 32, having diodes 321, 312 as sensor elements use the effect that diodes 311, 312 have a forward voltage that is dependent on the temperature. Silicon diodes have a negative temperature coefficient (of about −2 mV/K). The use of diodes as sensor elements has the advantage that diodes can easily be integrated in the semiconductor body, such as in the cell area of the power switch or in the logic section of a semiconductor body. It goes without saying that instead of diodes any other electronic devices that have a temperature dependent electrical characteristic may be employed as well. Examples are NTC resistors or PTC resistors, i.e. resistors that have a negative temperature coefficient (NTC) or a positive temperature coefficient (PTC). According to an example the first and second sensors 31, 32 have the same characteristic, i.e. the temperature signals S1₃, S2₃ have the same dependency on the temperature.

In the circuit according to FIG. 10 the ambient temperature signal S_{T} that is provided to the reference signal generator 4 is the second temperature signal S2₃. Therefore, the temperature at the second position P2 represents the ambient temperature in this example.

Referring to FIG. 12 the reference signal generator 4 that generates at least one of the temperature difference threshold signals may be a controlled voltage source 41 that receives the ambient temperature signal S_{T} and generates an output voltage S_{ΔTref} that is dependent on the temperature signal S_{T}.

FIG. 13 illustrates an example embodiment of the evaluation circuit 5. The evaluation circuit 5 has a first comparator 53 that receives the temperature difference signal S_{ΔT} at a first input and the threshold reference signal S_{ΔTref} at a second input. In the example the first input is the non-inverting input and the second input is the inverting input of comparator 53. Further, the threshold reference signal S_{ΔTref} represents the first (upper) temperature difference threshold S_{ΔTref1} in this example. A second comparator 54 receives the temperature difference signal S_{ΔT} and the second (lower) temperature difference threshold signal S_{ΔTref2}, this second signal representing the lower temperature difference threshold ΔTref2. The second threshold signal S_{ΔTref2} is a constant signal in this example and is provided by a reference voltage source 55. Evaluation circuit 5 further includes a flip-flop 56 that receives an output signal S53 of the first comparator 53 at a set input S, and an output signal S54 of a second comparator 54 at a reset input R, reset input R being an inverting input in this example. Thermal protection signal S2 is available at an output Q of flip-flop 56.

Evaluation circuit 5 provides the functionality that has been illustrated with reference to FIG. 3. Each time the temperature difference ΔT, that is represented by temperature difference signal S_{ΔT}, reaches the first threshold ΔTref1, that is represented by the first threshold signal S_{ΔTref1}, flip-flop 56 is set, resulting in a high signal level of thermal protection signal S2. In the present example a high-level of thermal protection signal S2 represents an overheating or fault level. If subsequently the temperature difference falls below the second temperature difference threshold ΔTref2, that is represented by the second threshold signal S_{ΔTref2}, flip-flop 56 is reset via second comparator 54, thereby resetting flip-flop 56. Resetting flip-flop 56 results in a low level of thermal protection signal S2, this low level representing a normal signal level of thermal protection signal S2.

In the evaluation circuit of FIG. 13 the hysteresis HY of the temperature difference is varied by varying the upper threshold ΔTref1. The evaluation circuit according to FIG. 13 is suitable for a temperature difference threshold signal S_{ΔTref} that has a negative temperature coefficient. Referring to FIGS. 11 and 12 such signal can be produced by providing a second temperature signal S2₃ that has a negative temperature coefficient and by using a voltage source 41 that provides an output voltage that increases with increasing temperature signal S_{T} and that decreases with decreasing temperature signal S_{T}.

If temperature sensors having a positive temperature coefficient are used, a voltage source 41 may be used that provides an output voltage that decreases with increasing temperature signal S_{T} and that increases with decreasing temperature signal S_{T}.

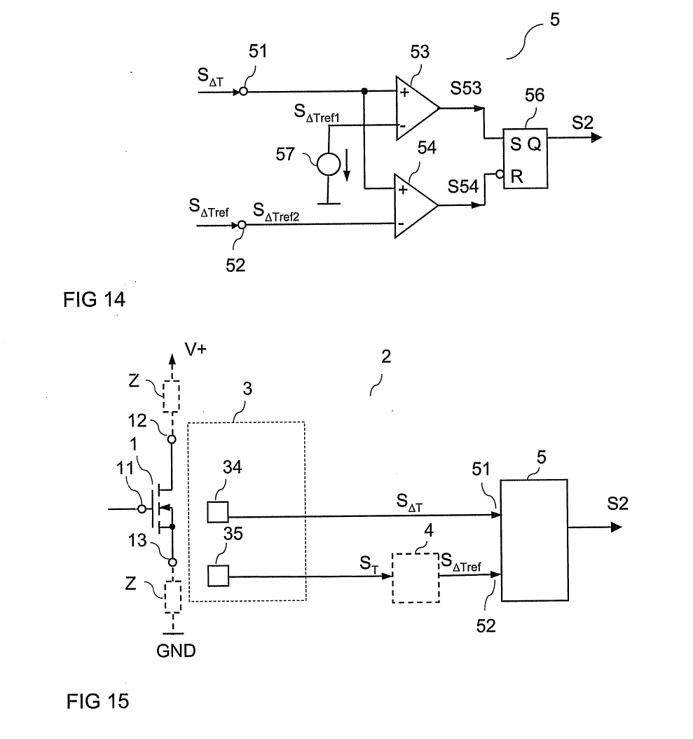

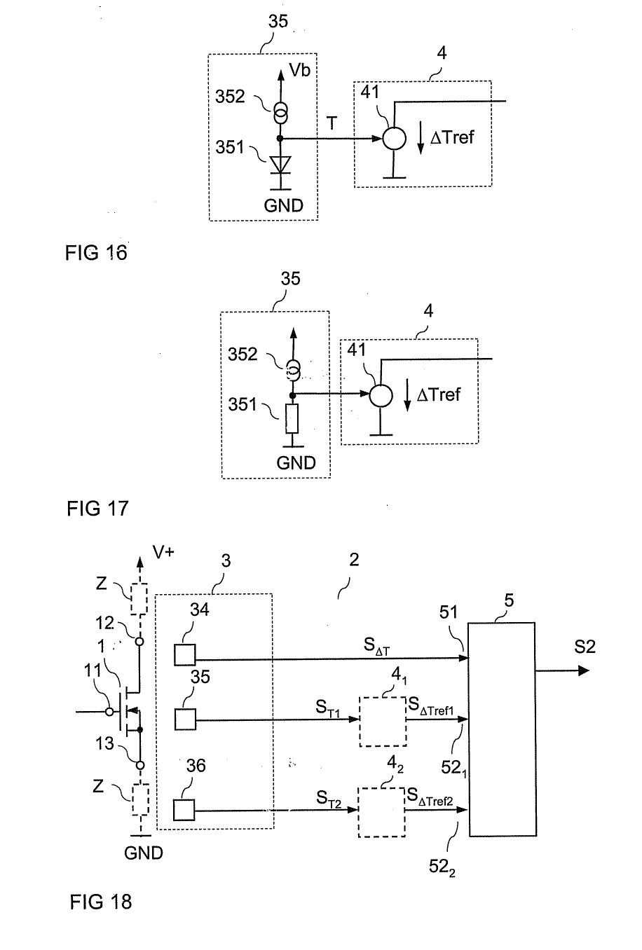

Instead of varying the upper temperature difference threshold the lower temperature difference threshold may be varied as well. FIG. 14 illustrates an example embodiment of an evaluation circuit 5 in which the lower threshold is varied. In this example first comparator 53 receives a fixed reference voltage S_{ΔTref1} from a reference voltage source 57, while the second comparator 54 receives the variable reference threshold voltage signal S_{ΔTref}, this temperature difference threshold voltage signal S_{ΔTref} representing the second threshold voltage ΔTref2 in this example. The second temperature difference threshold voltage signal S_{ΔTref2} has a positive temperature coefficient (as illustrated in FIG. 5). This may be obtained by using temperature sensors having a positive temperature coefficient or by using temperature sensors having a negative temperature coefficient and additionally using a reference voltage generator 4 that has a voltage source 41 (for example, see FIG. 16) providing an output voltage that increases with decreasing input signal S_{T} and decreases with increasing input signal S_{T}.

FIG. 15 illustrates a further example embodiment of the sensor arrangement 3. In this example the sensor arrangement includes a temperature difference sensor 34 that generates an output signal S_{ΔT} that is representative of the temperature difference between the temperatures at the first and second positions. This temperature difference sensor 34 is, for example, a Seebeck-effect thermal electric sensor. Since the temperature difference sensor 34 only provides an information on the temperature difference between the first and second positions but does not provide an information on the absolute temperature at any one of the first and second positions a second temperature sensor 35 is required that provides the ambient temperature signal S_{T}. As discussed before, the ambient temperature S_{T} can be the temperature at the second position P2 or can be the temperature at any other third position that is distant to the first position and distant to the hottest region in the power switch 1.

FIG. 16 illustrates an example embodiment of the second sensor 35. In this example second sensor 35 includes a bipolar diode 351 as a sensor element that is connected in series to a current source 352. A voltage drop across this diode 351 represents the ambient temperature signal S_{T}. The reference signal generator 4 generates the temperature difference threshold voltage signal S_{ΔTref} that may be used as the first or the second temperature difference threshold signal S_{ΔTref1}, S_{ΔTref2}. In this connection references are made to FIGS. 12, 13 and 14 and the description thereof.

Referring to FIG. 17 the second sensor 35 may include a temperature dependent resistor 351 as a sensor element. The additional reference signal generator 4 is optionally in this case, i.e. the output signal of sensor 35 may directly be used as the temperature difference threshold signal S_{ΔTref}, where this signal can be used as the first temperature difference threshold signal S_{ΔTref1} if resistor 351 is an NTC resistor, and can be used as the second temperature difference threshold signal S_{ΔTref2}, if the resistor is a PTC resistor. In this connection it should be noted that the reference signal generator 4 that has been explained before and that generates a temperature difference threshold signal S_{ΔTref} from temperature signal S_{T} is optional in all cases in which a temperature coefficient of the temperature signal S_{T} corresponds to the desired temperature coefficient of the temperature difference threshold signal S_{ΔTref}. In these cases temperature signal S_{T} is used as the temperature difference threshold signal S_{ΔTref}. However, some temperature sensors, such as forward-biased diodes, have output voltage that are to low to be used as the temperature difference threshold signal S_{ΔTref}. In these cases reference signal generator 4 is used to amplify the temperature signal S_{T} provided by the sensor arrangement 3.

FIG. 18 illustrates an example embodiment of the sensor arrangement 3 that besides the first and second sensors 34, 35 includes a third sensor 36. The second sensor 35 in this example provides a first ambient temperature signal S_{T1}, and the third sensor 36 provides a second ambient temperature signal S_{T2}. Second and third sensors 35, 36 have different temperature coefficients, i.e. one of these sensors, such as sensor 35 has a negative temperature coefficient, and the other sensor, such as sensor 36, has a positive temperature coefficient. The first ambient temperature signal S_{T1} is used to generate the first temperature difference threshold signal S_{ΔTref1} that represents the first threshold ΔTref1 and that is provided to an input 52₁ of the evaluation circuit 5, and the second ambient temperature signal S_{T2} is used to generate the second temperature difference threshold signal S_{ΔTref2} that represents the second temperature difference threshold ΔTref2 and that is provided to an input 52₂ of the evaluation circuit 5.

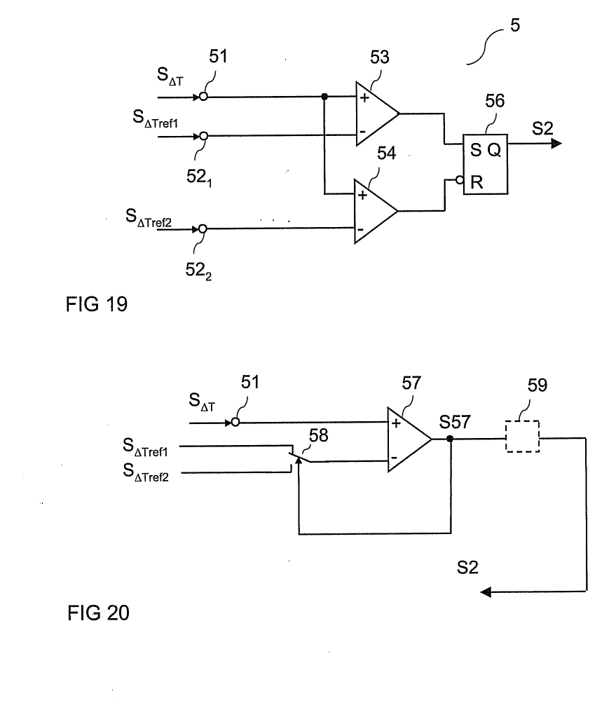

An example embodiment of the evaluation circuit 5 as illustrated in FIG. 18 is illustrated in FIG. 19. This evaluation circuit corresponds to the evaluation circuits according to FIGS. 13 and 14 except for that both, the first and second temperature difference threshold signals S_{ΔTref1}, S_{ΔTref2} are ambient temperature dependent, so that no fixed voltage source is present. In the arrangements according to FIGS. 18 and 19 both, the first and second temperature difference thresholds ΔTref1, ΔTref2 are adjusted dependent on the ambient temperature, the first threshold having a negative temperature coefficient, i.e. decreases with increasing temperature, and the second threshold having a positive temperature coefficient, i.e. increases with increasing temperature.

A further example embodiment of the evaluation circuit 5 is illustrated in FIG. 20. The evaluation circuit 5 includes a comparator that receives temperature difference signal S_{ΔT}, that is available at the first input 51 of evaluation circuit and that receives one of the first and second temperature difference threshold signals S_{ΔTref1}, S_{ΔTref2} at a second input. Temperature difference signal S_{ΔT} and first and second temperature difference threshold signals S_{ΔTref1}, S_{ΔTref2} may be generated by any of the means as explained before. The evaluation circuit 5 further includes a switch 58 being connected upstream to the second comparator input. Switch 58 receives the first and second temperature difference thresholds signals S_{ΔTref1}, S_{ΔTref2} and is controlled by an output signal S57 of the comparator. Dependent on a signal level of the comparator output signal S57 switch 58 either applies the first or the second temperature difference thresholds signal S_{ΔTref1}, S_{ΔTref2} to the second comparator input.

Comparator output signal 57 forms to the thermal protection signal S2. Optionally a delay element 59 is connected downstream to the output of comparator 57, delay element 59 delaying the thermal protection signal as compared to the comparator output signal S57 for a given delay time. This adds stability to the system and avoids oscillations.

Switch 58 is configured to apply the first temperature difference threshold signal S_{ΔTref1} to the second comparator input, if the thermal protection signal S2 has a normal signal level. If the temperature difference ΔT being represented by the temperature difference signal S_{ΔT} reaches or rises above the first temperature difference threshold ΔTref1 being represented by first temperature difference threshold signal S_{ΔTref1}, then the comparator output signal S57, and therefore thermal protection signal S2, changes its signal level to a fault level. Switch 58 then applies the second temperature difference threshold signal S_{ΔTref2} to the second comparator input. Comparator 57 changes its output signal level form the fault level to the normal level, if the temperature difference ΔT has fallen to the second temperature difference threshold ΔTref2 being represented by second temperature difference threshold signal S_{ΔTref2}.

In the example embodiment illustrated in FIG. 20 the normal signal level of thermal protection signal S2 is a low level. For generating this signal level first comparator input, that receives the temperature difference signal S_{ΔT}, is the non-inverting input of the comparator, and second comparator input, that receives one of the first and second temperature difference threshold signals S_{ΔTref1}, S_{ΔTref2} is the inverting input of the comparator.

It is to be understood that the features of the various exemplary embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of protecting a circuit arrangement including an integrated power dissipating device, the power dissipating device having a control terminal for receiving a control signal, the method comprising:
measuring a temperature difference between temperatures at a first position and a second position of the arrangement, the second position being distant to the first position;
generating a thermal protection signal, and generating the control signal dependent on the thermal protection signal; and
the thermal protection signal assuming a first signal level, if the temperature difference rises to a first temperature difference threshold, and assuming a second signal level, if the temperature difference falls to a second temperature difference threshold, and
at least one of the first and second temperature thresholds being dependent on the temperature at the second position or at a third position of the circuit arrangement.

2. The method of claim 1, in which the circuit arrangement comprises a semiconductor body, the semiconductor body comprising a power dissipating device section in which the power dissipating device is integrated, the first position being located in the power dissipating device section of the semiconductor body.

3. The method of claim 2, in which the second position is a position of the semiconductor body that is distant to the active region.

4. The method of claim 2, where the power dissipating device is a power switch, and in which active regions of the power switch are integrated in the power dissipating device section.

5. The method of claim 2, where the third position is a position of the semiconductor body that is distant to the active region.

6. The method of claim 2, in which the component arrangement further comprises a carrier on which the semiconductor body is mounted.

7. The method of claim 6, in which the second position is a position on the carrier.

8. The method of claim 1, in which measuring the temperature difference between temperatures at the first position and the second position includes:
measuring the temperature at the first position using a first temperature sensor to obtain a first temperature and measuring the temperature at the second position to obtain a second temperature;
calculating a temperature difference between the first and the second temperature.

9. A method of protecting a circuit arrangement including an integrated power dissipating device, the power dissipating device having a control terminal for receiving a control signal, the method comprising:
measuring a temperature difference between temperatures at a first position and a second position of the arrangement, the second position being distant to the first position;
generating a thermal protection signal, and generating the control signal dependent on the thermal protection signal; and
the thermal protection signal assuming a first signal level, if the temperature difference rises to a first temperature difference threshold, and assuming a second signal level, if the temperature difference falls to a second temperature difference threshold, and
at least one of the first and second temperature thresholds being dependent on the temperature at the second position or at a third position of the circuit arrangement; and
measuring the temperature difference using a thermoelectric temperature difference sensor.

10. The method of claim 9, in which the thermoelectric temperature difference sensor is a Seebeck sensor.

11. The method of claim 9, in which the first temperature difference threshold at least for a given temperature range decreases with increasing temperature.

12. The method of claim 9, in which the second temperature difference threshold at least for a given temperature range increases with increasing temperature.

13. A circuit arrangement comprising:
an integrated power dissipating device having a control terminal for receiving a control signal;
a thermal protection circuit, the thermal protection circuit being configured to measure a temperature difference between temperatures at a first position and a second position of the arrangement, the second position being distant to the first position, and to generate a thermal protection signal, assuming a first signal level, if the temperature difference rises to a first temperature difference threshold, and assuming a second signal level, if the temperature difference falls to a second temperature difference threshold; and
a drive circuit receiving the thermal protection signal and being configured to generate the control signal dependent on the thermal protection signal.

14. The circuit arrangement of claim 13, further comprising:
a semiconductor body, the semiconductor body comprising a power dissipating device section in which the power dissipating device is integrated, the first position being located in the power dissipating device section of the semiconductor body.

15. The circuit arrangement of claim 14, in which the second position is a position of the semiconductor body that is distant to the active region.

16. The circuit arrangement of claim 13, where in which the power dissipating device is a power switch; and in which active regions of the power switch are integrated in the power dissipating device section.

17. The circuit arrangement of claim 13, in which the thermal protection circuit comprises a sensor arrangement, the sensor arrangement comprising:
a first temperature sensor located at the first position, the first sensor being configured to provide a first temperature signal that is representative of a temperature at the first position;
a second temperature sensor located at the second position, the second sensor being configured to provide a second temperature signal that is representative of a temperature at the second position;
a circuit configured to calculate a difference between the first and the second temperature signals and providing a temperature difference signal.

18. The circuit arrangement of claim 13, further comprising:
a reference signal generator being configured to generate a temperature difference threshold signal that is dependent on the temperature at the first position;
an evaluation circuit that receives the temperature difference signal and the temperature difference threshold signal.

19. The circuit arrangement of claim 18, in which the reference signal generator receives the second temperature signal and generates the temperature difference threshold signal dependent on the second temperature signal.

20. The circuit arrangement of claim 18, in which the second sensor element is the reference signal generator.

21. The circuit arrangement of claim 13, in which the thermal protection circuit comprises a sensor arrangement, the sensor arrangement comprising:
a temperature difference sensor, the temperature difference sensor being configured to provide a temperature difference signal that is representative of a temperature difference between the temperatures at the first and second positions;
a further temperature sensor located at the second position or a third position, the second sensor being configured to provide a further temperature signal that is representative of a temperature at the second or third position.

22. The circuit arrangement of claim 21, further comprising:
a reference signal generator being configured to generate a temperature difference threshold signal that is dependent on the temperature at the second or third position;
an evaluation circuit that receives the temperature difference signal and the temperature difference threshold signal.

23. The circuit arrangement of claim 22, in which the reference signal generator receives the further temperature signal and generates the temperature difference threshold signal dependent on the second temperature signal.

24. The circuit arrangement of claim 22, in which the further sensor element is the reference signal generator.

25. An integrated power device comprising:
a power dissipating device comprising a power switch configured to receive a control signal based on a thermal protection signal; and
a thermal protection circuit configured to measure a temperature difference between a first position and a second position distant from the first position, and to generate the thermal protection signal having at least a first signal level corresponding to a first temperature difference threshold and a second signal level corresponding to a second temperature difference threshold.
